(19) United States
(12) Patent Application Publication
(10) Pub. No.: US 2012/0158601 A1
(43) Pub. Date: Jun. 21, 2012

(54) Defining And Monitoring Business Conduct

(76) Inventors: Martina Rothley, Schwetzingen (DE); Johann Kemmer, Muehlhausen (DE)

(21) Appl. No.: 12/969,409

(22) Filed: Dec. 15, 2010

(51) Int. Cl. G06Q 99/00

(52) U.S. Cl. 705/317

(57) ABSTRACT

A code of business standards can be defined for an entity according to at least one predetermined abstract business standard. The defining can include assigning, in the code of business standards, at least one threshold level of activity relating to the predetermined abstract business standard. Activity instances in the at least one area of activity involving the entity can be monitored, for example by identifying an activity instance in violation of the defined code of business standards. The identifying can include detecting that the activity instance exceeds the at least one threshold level of activity. A solution for resolving the identified activity instance can be generated and promoted. Related methods, system, and computer program products are also described.

### TECHNICAL FIELD

This disclosure relates generally to data processing and, in particular, to defining and monitoring business conduct of business partners, such as for example suppliers, distributors, and the like.

### BACKGROUND

Many currently available enterprise systems operate at an application platform in which business objects, which are a type of data object, describe a structure and behavior of real-world objects. A business object can include a hierarchy of business object nodes, which represent data as attributes, and can be an independently viable entity with identifiable instances. A business object can also bundle functions and data, both of which can be accessible from outside of the business object. Further, it can be described by a data model, an internal process model, and one or more service interfaces and can be a core structuring element of applications that are centrally defined by a developer as part of an overall governance process.

Various software applications currently employed by many industries involve usage of business objects. Business objects provide business object services in order to offer functionality to consumers. A developer typically performs a design of a system containing business objects as well as business objects themselves. Once the objects have been designed and tested, they can be typically provided to the end user for an appropriate use.

At the time of designing a business object, the business object can be defined using a business object model describing structural and functional entities of the business object. At the time of running a business object, the business object model is instantiated as a business object runtime model. When a business object service is invoked at runtime, the relevant functional entities are looked up in the model, instantiated and executed by a business object runtime. During a business object service execution, the business object runtime automatically executes functional entities whose triggering condition, for example as specified in the business object runtime model, is fulfilled.

### SUMMARY

In one aspect of the current subject matter, a computer-implemented method includes defining a code of business standards for an entity according to at least one predetermined abstract business standard. The defining includes assigning, in the code of business standards, at least one threshold level of activity relating to the predetermined abstract business standard. Activity instances are monitored in the at least one area of activity involving the entity. The monitoring identifying an activity instance in violation of the defined code of business standards by detecting that the activity instance exceeds the at least one threshold level of activity. A solution for resolving the identified activity instance is generated and promoted.

In optional variations, one or more of the following features may be included. The at least one predetermined abstract business standard can include at least one of an official standard, an internal standard, an external standard, a knowledge management standard, a quality management standard, a business intelligence standard, a supplier relationship management standard, a sales and distribution standard, a materials management standard, a financial accounting standard, and an external source. The official standard can include at least one of a government standard and an industry standard. The internal standard can include at least one standard determined based on at least one process internal to another entity having the defined code of business standards. The external standard can include at least one standard determined based on at least one process external to another entity having the defined code of business standards. The code of business standards can include at least one of structured criteria and unstructured criteria. The at least one area of activity can include at least one of a financial area, an environmental area, a legal area, and a political area. The entity can be an external entity that conducts business with an organization, and the monitoring can further include receiving, at a rules engine under the control of the organization, data characterizing the activity instances of the entity. The at least one solution can include at least one of requesting the entity to remove the violation, discontinuing a relationship with the entity, disregarding the violation, and modifying a relationship with the entity based on the determined violation. At least one of the defining, the monitoring, the generating, and the promoting can be performed on at least one processor. For example, a rules engine operating either on one or more processing systems local to the entity or on one or more external processors accessible to the entity over a network can perform at least the monitoring of the activity instances and the generating of one or more proposed solutions.

Articles are also described that comprise a tangibly embodied machine-readable medium embodying instructions that, when performed, cause one or more machines (e.g., computers, etc.) to result in operations described herein. Similarly, computer systems are also described that can include a processor and a memory coupled to the processor. The memory can include one or more programs that cause the processor to perform one or more of the operations described herein.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an exemplary system for defining and monitoring business conduct, according to some implementations of the current subject matter;

FIG. 2 illustrates another exemplary system for defining and monitoring business conduct, according to some implementations of the current subject matter;

FIG. 3 illustrates exemplary business conduct standards, according to some implementations of the current subject matter;

FIG. 4 illustrates an exemplary supplier evaluation, according to some implementations of the current subject matter;

FIG. 5 illustrates an exemplary system for responding to an alert concerning a supplier, according to some implementations of the current subject matter; and

FIG. 6 illustrates a method according to some implementations of the current subject matter.

### DETAILED DESCRIPTION

There is a need for defining and monitoring business conduct standards to mitigate various risks associated various business ventures, enterprises, conduct, and other behavior in advance. Further, there is a need for defining and monitoring business conduct standards based on existing industry standards in various areas, including financial, environmental, political, legal, social, and other sectors.

To address these and potentially other deficiencies of currently available solutions, one or more implementations of the current subject matter provide methods, systems, articles or manufacture, and the like that can, among other possible advantages, provide systems and methods for providing systems, methods, and computer program products for defining and monitoring business conduct standards.

In some situations, it may be important for a company (or an individual, or any other entity, etc.) to obtain assurances that its suppliers, business partners, and other entities doing business with the company are properly abiding by various industry standards, rules, laws, company's code(s) of business conduct, ethical rules and regulations, and/or any other regulations (collectively, “standards”). Such standards can be imposed by governing bodies, industry associations, commercial organizations, company's internal/external policies and procedures, and/or any other users/entities. These standards can be implemented in various areas, including, political, environmental, financial, legal, and/or any other areas. Non-limiting examples of standards can include UN Global Compact, BSCI, SA8000, Sustainability Standards, and/or any other standards. The following is a brief discussion of some of these standards.

Some implementations of the current subject matter can generate a body of business conduct standards for a particular user (e.g. a company, a corporation, a government entity, an individual, or any other entity) that can be based on various factors/standards, such as for example those described above, form a standards catalog based on the generated business conduct standards, use the standards catalog to monitor activities of other entities (e.g. companies, corporations, government entities, individuals, etc.) that are doing business with the user, and initiate various activities based on the monitoring that can be specific to the user and/or other entities that are doing business with the user. For ease of illustration, in the following discussion, the term “user” refers to individual(s), company(ies), corporation(s), government organization(s), and/or any other entity(ies) involved in forming a particular standards catalog. The terms “other entity” or “other entities” refer to individual(s), company(ies), corporation(s), government organization(s), and/or any other entity(ies) doing business with the user (e.g., supplying materials, purchasing from the user, selling to the user, providing goods and/or services to the user, and/or interacting with the user in any other fashion).

The standards catalog can be formed based on various standards, including official standards, industry standards, internal/external standards and/or code of business conduct pertaining to the user, and/or any other factors. Official standards, guidelines, regulations, rules, laws, etc. (e.g., government, industry, etc.) can be obtained from official sources (e.g., official standards can be downloaded or otherwise received from appropriate websites, such as, government websites, industry association websites, etc.). The official standards can include structured data, for example including self-defined criteria having various predetermined thresholds, values, etc. that can be used to evaluate conduct of entities. The standards can also include unstructured data that provide description of the standards in textual, graphical, and/or other formats.

Internal/external standards can be developed by the user in accordance with its own practices, standards, requirements, rules, etc. as well as requirements by governmental bodies, industry standards and practices, etc. Similarly, the internal/external standards can be in the form of structured data and/or unstructured data.

A combination of the official standards and user internal/external standards can be applied to define a standards catalog or business conduct standards catalog for the user. In some implementations, the standards catalog can contain business code standards, definitions of conduct that can be performed by the entities doing business with the user, rules governing business conduct between the user and the entities doing business with the user, and alert definitions. The alert definitions can alert the user that one of the standards, definitions, rules, etc. may have been violated by an entity doing business with the user and/or that one or more instances of conduct by the entity are inconsistent with standards, definitions, rules, etc. defined in the standards catalog, as well as any other actions and/or events that may be related to the user and/or to the entity doing business with the user.

In some implementations, a rules engine can be configured to monitor actions and events associated with the relationship between the user and the entity doing business with the user in view of the standards catalog and generate appropriate alerts to a user. Based on the alerts, the user can initiate various activities, such as investigation(s) into the causes of the alert, audit(s) of the entity doing business with the user and/or conduct by that entity, evaluation(s) of that entity, obtaining rating(s) for that entity from official organizations, negotiation(s) of guidelines (including contract(s)) governing entity's conduct and/or relationship between the user and the entity, as well as any other activities. In some implementations, such activities can be also scheduled either automatically based on the standards catalog provisions or manually based on passage of any predetermined period of time. The user can track performance of the activities via various progress reports and/or can be alerted to monitor tracking of the activities. In some implementations, the user can obtain reporting concerning performance of an activity at any time (either before the activity is initiated, at any stage during performance of an activity, and/or after the activity is completed).

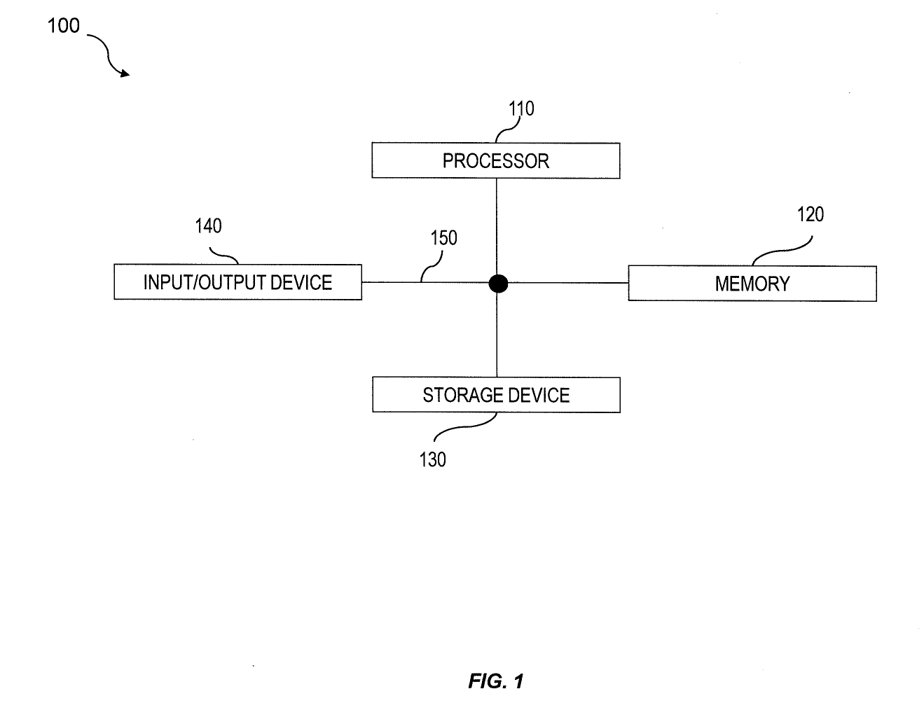

In some implementations, aspects of the current subject matter can be configured as a system 100, as shown in FIG. 1. The system 100 can include a processor 110, a memory 120, a storage device 130, and an input/output device 140. Each of the components 110, 120, 130 and 140 can be interconnected using a system bus 150. The processor 110 can be configured to process instructions for execution within the system 100. In some implementations, the processor 110 can be a single-threaded processor. In alternate implementations, the processor 110 can be a multi-threaded processor. The processor 110 can be further configured to process instructions stored in the memory 120 or on the storage device 130, including receiving or sending information through the input/output device 140. The memory 120 can store information within the system 100. In some implementations, the memory 120 can be a computer-readable medium, a volatile memory unit, or the like. The storage device 130 can be capable of providing mass storage for the system 100. In some implementations, the storage device 130 can be a computer-readable medium, a floppy disk device, a hard disk device, an optical disk device, a tape device, non-volatile solid state memory, or any other type of storage device. The input/output device 140 can be configured to provide input/output operations for the system 100. In some implementations, the input/output device 140 can include a keyboard, pointing device, touch screen interface, a display unit for displaying graphical user interfaces, and the like.

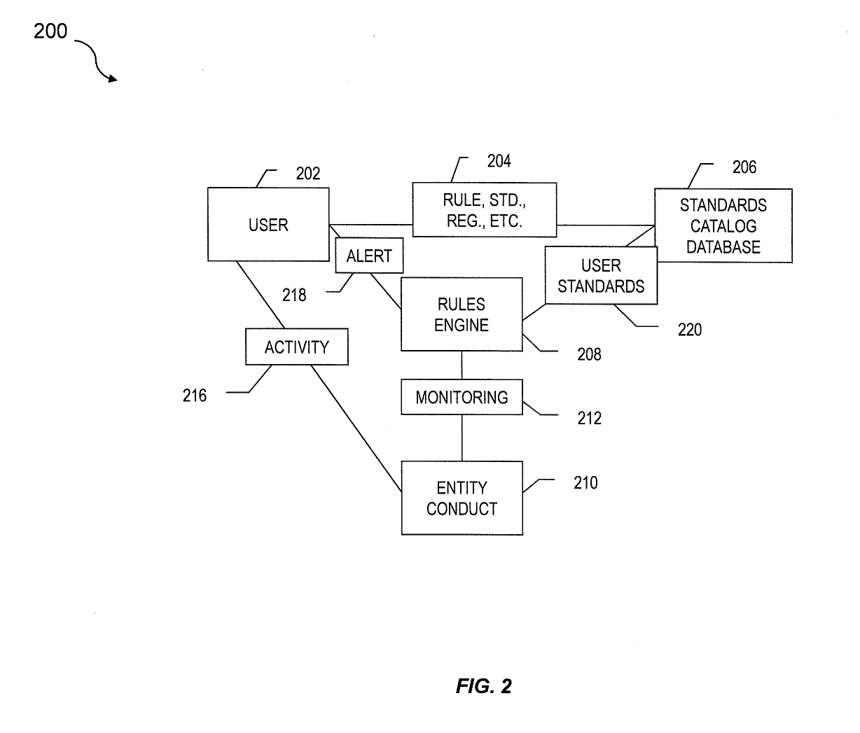

FIG. 2 illustrates an exemplary system 200 that can allow a user 202 to generate a standards catalog 206 (which can be stored in a database or in any other repository) based on a plurality of official standards, regulations, laws, rules, industry provisions, standards of business conduct internal/external to the user 204. The standards catalog can be provided to a rules engine 208 as user standards 220, where the rules engine 208 can be configured to monitor 212 conduct 210 of an entity or any conduct associated with or otherwise related to the relationship between the user and the entity. If the rules engine 208 determines that the conduct of the entity and/or other events that may be relevant to the relationship between the user and the entity are violated or otherwise are inconsistent with at least one standard defined in the standards catalog, the rules engine 208 can generate an alert 218 to the user 202. The user 202 can initiate an activity 216 in response to the alert 218. The activity 218 can also be initiated without receiving an alert (either automatically or manually), especially for those “weak” or unstructured criteria, that do not allow the regulation by quantitative measurements. The activity 218 can include an audit of the entity and/or its conduct, obtaining various ratings of the entity, performing reviews and/or evaluations, etc. The user 202 can also track performance of the activity via reports.

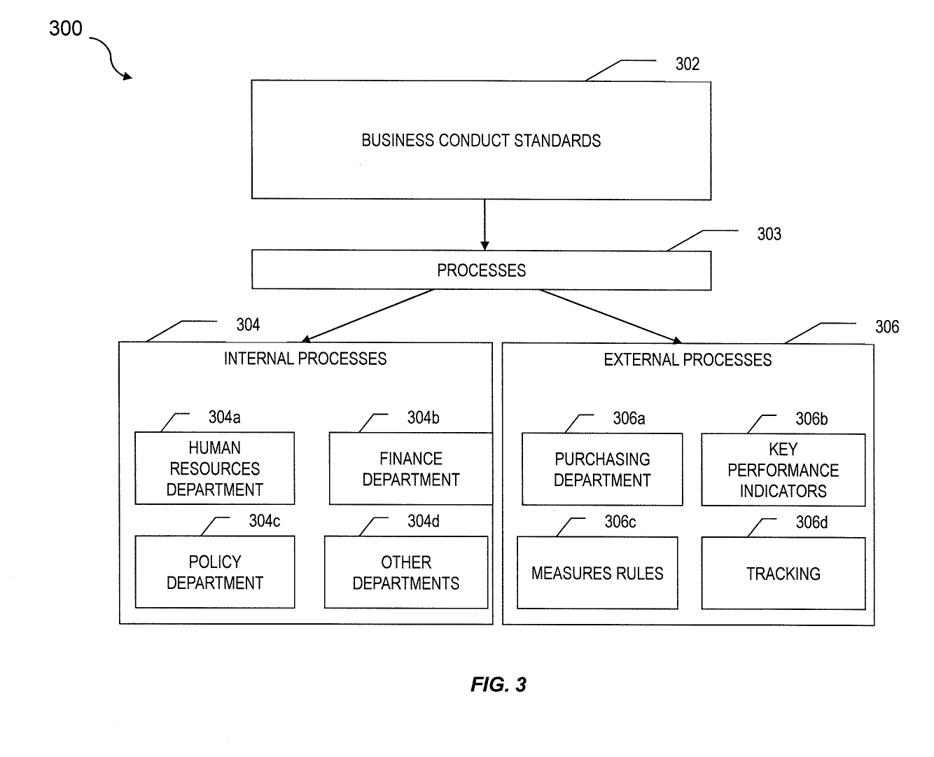

FIG. 3 illustrates a system 300 including features consistent with one or more implementations of the current subject matter with regard to a business relationship between a company and a supplier of various products/materials to the company. At the outset, the company's management defines a code of business conduct 302 that can be used for the company itself as well as its suppliers. Cross-organizational teams of the company, which can include human resources members, corporate environment members, purchasing department members, and other members of the company's various departments, can be provided with the code of business conduct 302 and can be obligated to abide by its provisions. The code of business conduct 302 can include a plurality of internal processes, provisions, standards, rules, regulations, etc. 304 that can be specifically applicable to one or more company departments respective members of those departments (e.g., human resources department members 304a) and a plurality of external processes, provisions, standards, rules, regulations, etc. 306. As shown in FIG. 3, the external processes can include company's purchasing department processes, provisions, standards, rules, regulations, etc. 306a, key performance indicator (“KPI”) definitions 306b, measures and rules 306c, and tracking 306d. The external processes 306 are also applicable to company's suppliers, customers, etc. The external processes that can be implemented by the company's purchasing department 306a can use key performance indicators 306b to analyze suppliers based on product categories and product as well as analyze potential risks and impacts on the company's business that may be associated with the company dealing with a particular supplier. The company can also use measures and rules 306c to obtain information on the suppliers and based on that information determine whether suppliers comply with company's business conduct standards. The measures can include, but are not limited to, requiring suppliers to complete questionnaires, performing audits of suppliers, research on the World Wide Web for any information that may be related to suppliers, use of rating organizations to obtain various ratings for suppliers (e.g., Moody's Investor Service, Standard & Poor's, Fitch Ratings, A. M. Best Company, Dominion Bond Rating Service, Ltd., Japan Credit Rating Agency, Ltd., R&I, Inc., Egan-Jones Rating Company, LACE Financial, Realpoint LLC, and others), as well as any other measures that can be undertaken to obtain information about or otherwise related to company's suppliers. One or more of the measures can be formulated as rules and provided to the rules engine so that the rules engine can automatically alert the company in the event one of the company's business conduct standards is violated. Alternatively or in addition, the rules engine can perform any of the measures automatically or manually with or without receiving an indication of violation of a particularly standard in the company's business conduct standards. The company can also include a tracking process 306d that allows the company to keep track of the suppliers' compliance with company's business conduct standards as well as receive reports concerning performance of any activities. Such reports can be provided electronically (e.g., email, media mail, regular mail, telephone calls, media calls, or in any other fashion).

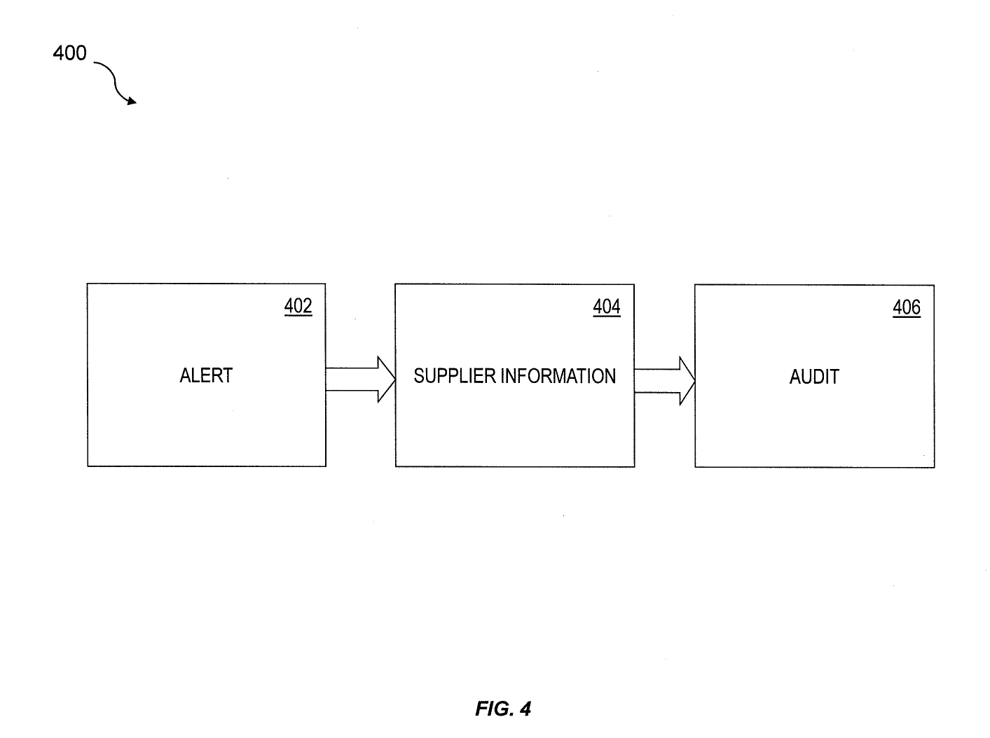

Referring to the process flow chart 400 of FIG. 4, the company can evaluate its suppliers based on receiving automatic alerts 402. Upon receiving an alert 402, the company can be configured to check or request supplier's information 404, and upon receiving such information, the company can execute various measures or activities, e.g., supplier's auditing, 406.

In some implementations, the alerts and any corresponding triggers can be predetermined by the company in its business conduct standards. The alerts can be generated based on the supplier exceeding appropriate thresholds, which can be predetermined in the business conduct standards. The predetermined threshold can be based on various key performance indicators (“KPIs”), which can be monitored by the company (or its rules engine) in various areas, such as, financial, environmental, legal, political, and/or any other areas. For example, a company's business conduct standards may state that its suppliers cannot implement any child labor in making its products. If the supplier were to start using child labor, the company can receive an alert indicating that the KPI corresponding to the standard defined in the company's business conduct standards has been violated. By way of another example, one of the company's standards can state that its supplier must provide products that are made from materials that are at least 50% recycled. If, for example, the supplier were to begin producing products containing only 40% recycled materials, the company would receive an alert that can indicate that the supplier is providing products that are made from materials that are less than 50% recycled. In some implementations, the alert might not have to relate to the supplier per se but can be related to political, financial, environmental, legal, social, etc. environment in which the supplier is located and/or operates. For example, if the supplier is located and/or operates in a country that recently had a change in government (e.g., military coup), the company can choose to reevaluate its relationship with the supplier based on the information concerning the new government. Alerts can be also generated based on information concerning subcontractors or entities that may be associated with the supplier. Alerts can be generated based on any number of factors that may relate to the relationship between the company and its supplier.

Upon receiving the alert concerning a supplier, the company can request information about or related to the supplier. This information can include, but is not limited to, a supplier's address and business data; financial situation (whether related to the supplier per se or to the environment in which supplier is located and/or operates); collaboration degree including any intellectual property rights, obligations, violations, etc.; historical data concerning the supplier's spending; data concerning suppliers planned spending; the supplier's evaluation score (which can be obtained from other sources, such as rating agencies, or previously generated by the company); various supplier documentation, including for example critical documents (e.g., complaints against the supplier, overdue deliveries, invoices with exceptions, and any other documentation), and other knowledge-base documentation; and any comments concerning the supplier. Using this information, the company can generate “supplier at a glance” information that can be used to evaluate, audit or otherwise review the supplier and the company's relationship with the supplier.

Once the company has the supplier information, the company can execute supplier auditing 406 (or any other activity that the company can determine to be appropriate in view of the received alert and/or supplier information). The auditing can be performed using various templates that the company may have generated as part of its business conduct standards. In the event of an audit, the templates can includes an audit schedule (e.g., time of the audit, individuals/entities involved in the audit and their corresponding roles, etc.), aspects of supplier's business that the company will audit, and audit reports that the company expects to generate as a result of the audit. The company can optionally review conduct of and/or any information related to the supplier, rather than conducting a formal audit.

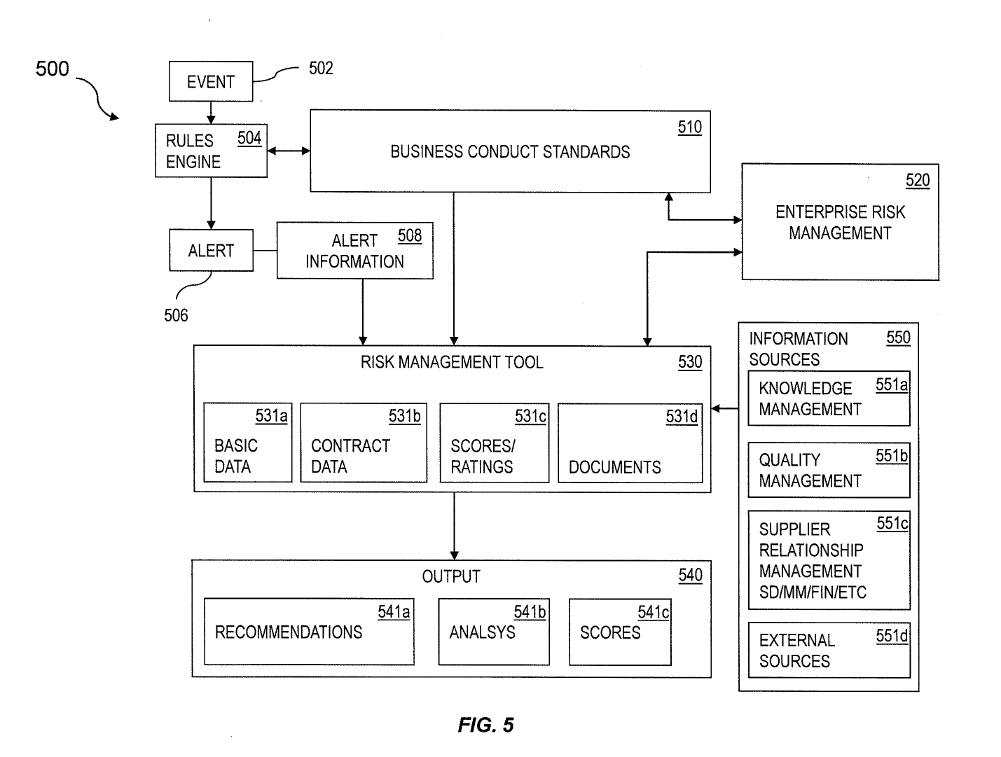

FIG. 5 illustrates a system 500 for determining a company's response to receipt of an alert concerning a particular supplier. As stated above, the company can create business conduct standards 510, which can be a combination of governmental standards, industry standards, internal/external policies and codes of conduct pertinent to the company, and/or any other rules, law, regulations, provisions, recommendations, etc. The business conduct standards 510 can be stored in a memory, a repository, a database, or in any other location/fashion. The system 500 can also include a rules engine 504 that can access a memory location (e.g., a database) that can contain the business conduct standards 510. The engine 504 can be configured to monitor conduct by entities that are doing business with the company (e.g., company's suppliers) or any other events that may be related to the company and entities that are doing business with the company. Upon receiving information concerning an event that may be of interest to the company, the rules engine 504 generates an alert 506 and provides alert information 508 to the company's risk management tool 530. The risk management tool 530 can analyze the information received and determine company's risks associated with continuing business relations with the entity regarding which alert information was received. The risk management tool 530 can also provide an output 540. The output 540 can include various recommendations 541a concerning strategies for proceeding forward, analysis 541b of the alert information in view of company's business conduct standards 510 as well as any other variables, scores or ratings of the entity regarding which alert was received as well as provide various data/documentation concerning the entity, business relationship with the entity, and any other information.

The risk management tool 530 can use various inputs to prepare output 540. These inputs can include alert information 508, business conduct standards 510, enterprise risk management (“ERM”) 520 inputs, data/information coming from various information sources 550, as well as any other inputs.

The alert information 508 can include information concerning the received input. This information can include the nature of the alert, the cause of the alert being generated, and the like. For example, the alert can be generated based on the entity having violating a standard defined in the company's business conduct standards (e.g., use of child labor in entity's factories to make products supplied to the company, where the company strictly forbids it). Alternatively, the company can automatically or manually audit/review/request information from the entity without receiving any alerts.

As stated above, the business conduct standards 510 can include a plurality of standards that are used by the company and where the company can ask and/or require that any entity that wishes to do business with the company abide by its standards. Information concerning these standards can be provided to the risk management tool 530.

The ERM 520 can include methods used by the company to manage risks and seize opportunities related to the achievement of its various objectives. The ERM 520 can provide a framework for risk management, which can involve identifying particular events or circumstances relevant to the company's objectives (i.e., risks and opportunities), assessing them in terms of likelihood and magnitude of impact, determining a response strategy, and monitoring progress. By identifying and proactively addressing risks and opportunities, the company can protect and create value for its stakeholders, including owners, employees, customers, regulators, and society overall. The ERM 520 can be a risk-based approach to managing the company, integrating concepts of, for example, internal control, the Sarbanes-Oxley Act, strategic planning, and other concepts. Various ERM frameworks can identify, analyze, respond to, and monitor risks and opportunities within the internal and external environment facing the company. Management of the company can select a risk response strategy for specific risks that are identified and analyzed. Some exemplary response strategies can include avoidance (i.e., exiting the activities giving rise to risk), reduction (i.e., taking action to reduce the likelihood or impact related to the risk), share or insure (i.e., transferring or sharing a portion of the risk, to reduce it), and acceptance (i.e., no action is taken, due to a cost/benefit decision). Other strategies can be devised based on a particular event, alert, entity, surrounding environment (e.g., political, financial, environmental, legal, etc.) and any other factors.

The information sources 550 can obtain information from sources such knowledge management 551a, quality management 551b, supplier relationship management, sales and distribution, materials management, financials, and the like 551c and external sources 551d. The knowledge management 551a can be a range of strategies and practices that can be used by the company to identify, create, represent, distribute, and enable adoption of insights and experiences. Such insights and experiences can include knowledge, either embodied in individuals or embedded in organizational processes or practice. The quality management 551b can include quality planning, quality control, quality assurance and quality improvement can be focused not only on product/service quality, but also on the means to achieve it. Quality management can use quality assurance and control of processes as well as products to achieve more consistent quality. Supplier relationship management 551c and/or materials management can include information concerning suppliers that may be vital to the company as well as information on how to maximize the potential value of those relationships. Sales and distribution software modules 551c can provide customer feedback/complaints regarding quality of delivered goods or services which the company has bought directly from the suppliers which shipped it to the customers. Materials management 551c can include supplier evaluation tools which deliver results in the area of the supplier's reliability regarding prices, delivery dates, quality and so on. Financials (e.g. financial accounting) modules 551c can offer analyses on supplier spend volumes which classifies the importance of a supplier for the companies business, or on other business partners (like customers). The external sources 551d can include information obtained from the World Wide Web, newspapers, television, observers and/or experts that may be hired by the company, as well as any other sources.

The risk management tool 530 can integrate information obtained from the alert information 508, the business conduct standards 510, the ERM 520, the information sources 550, and/or other sources to generate basic data 531a, contract data 531b, scores/ratings 531c of the entity, and documents 531d. The basic data 531a concerning the entity doing business with the company, whether or not alert is received concerning the entity, can include entity name, address, management information, etc. The contract data 531b can include any licenses, contracts, obligations, and any other conditions that can affect the business relationship between the company and the entity. The scores/ratings 531c of the entity can be obtained from various sources or internally generated by the company. Documents 531d can include various documentation concerning entities financial data (e.g., historical or future sales data, delivery obligations, production data, subcontractor information and corresponding financial data, etc.), legal obligations (e.g., litigations, settlements, mediations, arbitrations, violations, prosecutions, etc.), intellectual property rights (patents, trademarks, copyrights, trade secrets, etc.), regulatory information (e.g., governmental provisions that the entity is required to comply, governmental licenses and permits, etc.), environmental compliance (e.g., pollutant information, green ratings, etc.), and any other documentation. Such documentation can be requested by the company, provided voluntarily by the entity, and or can be available from various sources.

Upon completion of its analysis, the risk management tool 530 can generate output 540, which can include recommendations 541a for proceeding forward, outline of the analysis performed 541b, various scoring information 541c, and any other information that may be useful for the company to assess its risks, benefits, etc. for continuing to maintain its business relationship with the entity. The tool 530 can recommend that the company terminate the business relationship with the entity, renegotiate terms and conditions of the business relationship with the entity, request that the entity alter its practices, and/or continue maintaining relationship with the entity despite the risks involved for the company (e.g., the entity may be the only supplier of a product that is vital to the company's business).

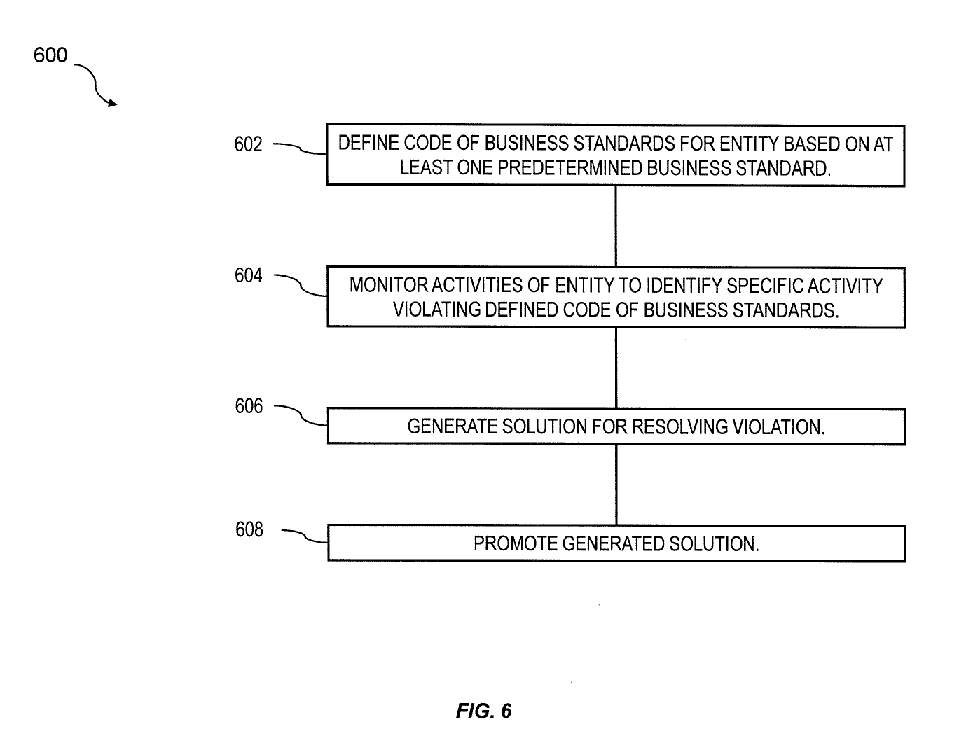

FIG. 6 shows a process flow chart 600 illustrating at least features consistent with implementations of the current subject matter. At 602, a code of business standards for an entity can be defined based on at least one predetermined abstract business standard and stored for access by a processor. The defining can include assigning, in the code of business standards, at least one threshold level of activity relating to the predetermined abstract business standard. At 604, activity instances in the at least one area of activity involving the entity can be monitored. The monitoring can identify an activity instance in violation of the defined code of business standards, for example by detecting that the activity instance exceeds the at least one threshold level of activity. At 606, one or more solutions for resolving the violation associated with the activity instance can be generated. The solution can be promoted at 608. Promoting can optionally include at least one of displaying the solution to a user via a visual display device, generating an alert and delivering the alert to an individual or group at the entity that is tasked with standards compliance, storing the solution on a data storage device, and aggregating the solution with one or more other solutions previously generated in the area of activity.

In some implementations, one or more of the following features can also be included. The code of business standards can include at least one of the following: an official standard, an internal standard, an external standard, a knowledge management standard, a quality management standard, a business intelligence standard, a SRM/SD/MM/FIN standard, and an external source. The official standard can include at least one of the following: a government standard and an industry standard. The internal standard can include at least one standard determined based on at least one process internal to another entity having the defined code of business standards. The external standard can include at least one standard determined based on at least one process external to another entity having the defined code of business standards. The code of business standards can include structured criteria and/or unstructured criteria. The monitoring can include at least one of an automatic monitoring and a manual monitoring. The monitoring can be performed in at least one area of activity by the entity, wherein the at least one area of activity can include at least one of the following: a financial area, an environmental area, a legal area, and a political area. The determining can include determining whether the at least one activity violates the at least one defined threshold level of activity. The at least one solution can include at least one of requesting the entity to remove the violation, discontinuing a relationship with the entity, disregarding the violation, and modifying a relationship with the entity based on the determined violation.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

Aspects of the subject matter described herein can be embodied in systems, apparatus, methods, and/or articles depending on the desired configuration. In particular, various implementations of the subject matter described herein can be realized in digital electronic circuitry, integrated circuitry, specially designed application specific integrated circuits (ASICs), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. A client and server are generally, but not exclusively, remote from each other and typically interact through a communication network, although the components of the system can be interconnected by any form or medium of digital data communication. Examples of communication networks include, but are not limited to, a local area network (“LAN”), a wide area network (“WAN”), and the Internet. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail herein, other modifications or additions are possible. In particular, further features and/or variations can be provided in addition to those set forth herein. For example, the implementations described above can be directed to various combinations and sub-combinations of the disclosed features and/or combinations and sub-combinations of one or more features further to those disclosed herein. In addition, the logic flows depicted in the accompanying figures and/or described herein do not necessarily require the particular order shown, or sequential order, to achieve desirable results. The scope of the following claims may include other implementations or embodiments.

What is claimed:

1. A method comprising,
defining a code of business standards for an entity according to at least one predetermined abstract business standard, the defining comprising assigning, in the code of business standards, at least one threshold level of activity relating to the predetermined abstract business standard;
monitoring activity instances in the at least one area of activity involving the entity, the monitoring identifying an activity instance in violation of the defined code of business standards, the identifying comprising detecting that the activity instance exceeds the at least one threshold level of activity;
generating a solution for resolving the identified activity instance; and
promoting the solution.

2. A method as in claim 1, wherein the at least one predetermined abstract business standard comprises at least one of an official standard, an internal standard, an external standard, a knowledge management standard, a quality management standard, a business intelligence standard, a supplier relationship management standard, a sales and distribution standard, a materials management standard, a financial accounting standard, and an external source.

3. A method as in claim 2, wherein the official standard comprises at least one of a government standard and an industry standard, the internal standard comprises at least one standard determined based on at least one process internal to another entity having the defined code of business standards, and the external standard comprises at least one standard determined based on at least one process external to another entity having the defined code of business standards.

4. A method as in claim 1, wherein the code of business standards comprises at least one of structured criteria and unstructured criteria.

5. A method as in claim 1, wherein the entity is an external entity that conducts business with an organization; and the monitoring further comprises receiving, at a rules engine under the control of the organization, data characterizing the activity instances of the entity.

6. A method as in claim 1, wherein the at least one solution comprises at least one of requesting the entity to remove the violation, discontinuing a relationship with the entity, disregarding the violation, and modifying a relationship with the entity based on the determined violation.

7. A method as in claim 1, wherein at least one of the defining, the monitoring, the generating, and the promoting is performed on at least one processor.

8. A system comprising,
at least one programmable processor; and
a machine-readable medium storing instructions that, when executed by the at least one programmable processor, cause the at least one programmable processor to perform operations comprising:
defining a code of business standards for an entity according to at least one predetermined abstract business standard, the defining comprising assigning, in the code of business standards, at least one threshold level of activity relating to the predetermined abstract business standard;
monitoring activity instances in the at least one area of activity involving the entity, the monitoring identifying an activity instance in violation of the defined code of business standards, the identifying comprising detecting that the activity instance exceeds the at least one threshold level of activity;
generating a solution for resolving the identified activity instance; and
promoting the solution.

9. A system as in claim 8, wherein the at least one predetermined abstract business standard comprises at least one of an official standard, an internal standard, an external standard, a knowledge management standard, a quality management standard, a business intelligence standard, a supplier relationship management standard, a sales and distribution standard, a materials management standard, a financial accounting standard, and an external source.

10. A system as in claim 9, wherein the official standard comprises at least one of a government standard and an industry standard, the internal standard comprises at least one standard determined based on at least one process internal to another entity having the defined code of business standards, and the external standard comprises at least one standard determined based on at least one process external to another entity having the defined code of business standards.

11. A system as in claim 8, wherein the code of business standards comprises at least one of structured criteria and unstructured criteria.

12. A system as in claim 8, wherein the entity is an external entity that conducts business with an organization; and the monitoring further comprises receiving, at a rules engine under the control of the organization, data characterizing the activity instances of the entity.

13. A system as in claim 8, wherein the at least one solution comprises at least one of requesting the entity to remove the violation, discontinuing a relationship with the entity, disregarding the violation, and modifying a relationship with the entity based on the determined violation.

14. A system as in claim 8, wherein the operations further comprise executing a rules engine that a rules engine that performs at least the monitoring of the activity instances and the generating of the solution.

15. A computer program product comprising a machine-readable medium storing instructions that, when executed by at least one programmable processor, cause the at least one programmable processor to perform operations comprising:
defining a code of business standards for an entity according to at least one predetermined abstract business standard, the defining comprising assigning, in the code of business standards, at least one threshold level of activity relating to the predetermined abstract business standard;
monitoring activity instances in the at least one area of activity involving the entity, the monitoring identifying an activity instance in violation of the defined code of business standards, the identifying comprising detecting that the activity instance exceeds the at least one threshold level of activity;
generating a solution for resolving the identified activity instance; and
promoting the solution.

16. A computer program product as in claim 15, wherein the at least one predetermined abstract business standard comprises at least one of an official standard, an internal standard, an external standard, a knowledge management standard, a quality management standard, a business intelligence standard, a supplier relationship management standard, a sales and distribution standard, a materials management standard, a financial accounting standard, and an external source.

17. A computer program product as in claim 16, wherein the official standard comprises at least one of a government standard and an industry standard, the internal standard comprises at least one standard determined based on at least one process internal to another entity having the defined code of business standards, and the external standard comprises at least one standard determined based on at least one process external to another entity having the defined code of business standards.

18. A computer program product as in claim 17, wherein the code of business standards comprises at least one of structured criteria and unstructured criteria.

19. A computer program product as in claim 15, wherein the entity is an external entity that conducts business with an organization; and the monitoring further comprises receiving, at a rules engine under the control of the organization, data characterizing the activity instances of the entity.

20. A computer program product as in claim 15, wherein the at least one solution comprises at least one of requesting the entity to remove the violation, discontinuing a relationship with the entity, disregarding the violation, and modifying a relationship with the entity based on the determined violation.
